(19) United States
(12) Patent Application Publication
(10) Pub. No.: US 2011/0234488 A1
(43) Pub. Date: Sep. 29, 2011

(54) PORTABLE ENGINE FOR ENTERTAINMENT, EDUCATION, OR COMMUNICATION

(75) Inventors: Shuzhi Ge, Singapore (SG); Junsong Hou, Singapore (SG); Bin Wang, SIngapore (SG)

(73) Assignee: NATIONAL UNIVERSITY OF SINGAPORE, Singapore (SG)

(21) Appl. No.: 13/131,373

(22) PCT Filed: Dec. 1, 2009
(86) PCT No.: PCT/IB2009/007728

§ 371 Date: May 26, 2011

Related U.S. Application Data
(60) Provisional application No. 61/118,733, filed on Dec. 1, 2008.

(51) Int. Cl. G09G 5/00

(52) U.S. Cl. 345/156

(57) ABSTRACT

To simplify human-machine interaction, a portable interaction module includes multiple channels through which input is received. Different types of input mechanisms or sensors allow use of multiple techniques for capturing input, such as motion sensing, audio sensing, image tracking, image sensing, or physiological sensing. A fusion module included in the portable input device receives data from the input mechanisms or sensors and generates an input description identifying which input mechanisms or sensors receive data. The input description is communicated to a target device, which determines an output corresponding to the input description. Using multiple input capture techniques simplifies interaction with the target device by providing a variety of methods for obtaining input.

### CROSS REFERENCE TO RELATED APPLICATIONS

This application claims the benefit of U.S. Provisional Application No. 61/118,733, filed Dec. 1, 2008, which is incorporated by reference in its entirety.

### BACKGROUND

This invention relates generally to human-machine interactions, and more particularly to a portable engine for human-machine interaction.

Rapidly evolving communication technologies and increasing availability of various sensory devices has provided an increasingly varied range of options for human-machine interfaces, such as interfaces for use in education, entertainment or healthcare. For example, wireless sensors now allow real-time monitoring of a person's physiological signals, such as electrocardiogram (ECG) or photoplethysmogram (PPG). However, commonly used human-machine interfaces, such as a keyboard, a mouse, or a pad-type controller, remain inconvenient for machine interaction, such as text entry, in various situations, such as education or documentation.

Commonly used human-machine interfaces, such as a keyboard, a mouse, or a pad-like controller, have a variety of limitations. For example, commonly used human-machine interfaces provide limited tactile feedback and have rigid structures preventing user customization of the human-machine interface based on personal preferences or environmental scenarios. For example, the predefined layout of keys on a keyboard prevents different users from defining personalized key layouts based on individual use preferences. Hence, users typically adapt their usage patterns in response to the fixed design of different human-machine interfaces. In addition to forcing user adaptation, the fixed design of conventional human-machine interfaces slows human interaction with a machine.

Additionally, many existing human-machine interfaces have limited use scenarios. For example, a flat or relatively flat surface is needed to easily provide input via keyboard. Further, certain human-machine interfaces require a user to alternate between different interfaces for machine interaction, such as alternating between use of a keyboard and a mouse, reducing efficiency of human-machine interaction. Further, prolonged use of commonly used conventional human-machine interfaces often leads to user fatigue. For example, a user's wrist and arm position are unnaturally positioned when using a keyboard, causing fatigue and also cause repetitive stress injuries to the user.

### SUMMARY

Embodiments of the invention provide a portable interaction module receiving input from various sources. The portable interaction module includes a fusion module coupled to one or more input devices which comprise a plurality of sensors and input mechanisms. The input mechanisms, such as buttons, keys, touch sensors or light sensors, receive input from interactions with the input mechanisms themselves. The sensors, such as a motion sensor, an imaging sensor, an audio sensor or a physiological sensor, capture data associated with an environment surrounding the portable interaction module. For example, the sensors capture data describing movement of portable interaction module, capture audio data or image data from an environment proximate to the portable input module or capture physiological data associated with a person proximate to the portable interaction module. The fusion module generates an input description describing data received by the input device. For example, the input description describes data received by the input mechanisms and/or data received by the sensors. As another example, the input description identifies a state associated with different input mechanisms and associates captured data with a secondary input device. The input description allows the input device to capture or obtain data from multiple input mechanisms or sensors, increasing the input sources. A communication module transmits the input description to a target device which determines an output based upon the input description.

The number and type of input mechanisms or sensors used to receive input or acquire data may be modified, allowing different implementations to differently receive input. Additionally, the target device may include settings associating an action or application with a value of the input description. These settings allow input or data from different input devices or different types of input to be differently interpreted by the target device. For example, different users of the portable interaction module may associate different input descriptions with a single action by the target device, allowing individual users to differently interact with the target device.

### BRIEF DESCRIPTION OF THE DRAWINGS

FIG. 1 is a high-level block diagram of a system including a portable interaction module in accordance with an embodiment of the invention.

FIG. 2 is a high-level block diagram of another system including a portable interaction module in accordance with an embodiment of the invention.

FIG. 3 is a high-level block diagram of an input device in accordance with an embodiment of the invention.

FIG. 4 is a high-level block diagram of a portable input module in accordance with an embodiment of the invention.

FIG. 5 is a flow chart of a method for receiving input from a portable interaction module in accordance with an embodiment of the invention.

FIG. 6 is an event diagram of a method for generating output responsive to input from a portable interaction module in accordance with an embodiment of the invention.

FIG. 7 is a flow chart of a method for configuring a system including a portable interaction module in accordance with an embodiment of the invention.

FIG. 8A is a perspective view of an example portable interaction module design in accordance with an embodiment of the invention.

FIG. 8B is an example system including a portable interaction module in accordance with an embodiment of the invention.

FIG. 9 is an alternate example portable interaction module design in accordance with an embodiment of the invention.

FIG. 10 is an example user interface for configuring a portable interaction module in accordance with an embodiment of the invention.

The Figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Portable Interaction Module System Architecture

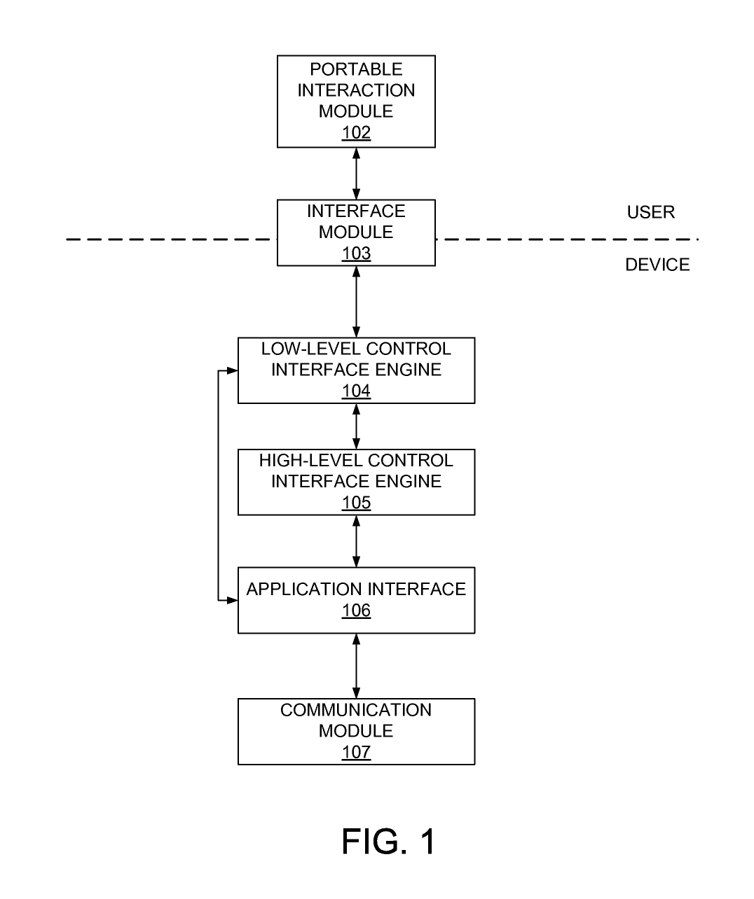

A high-level block diagram of a system 100 including a portable interaction module 102 is illustrated in FIG. 1. In one embodiment, the portable interaction module 102 receives input from a user and is coupled to an interface module 103 which receives input data from the portable interaction module 102 and communicates the received input data to a target device, such as a desktop computer, a gaming system or other computing system. In the embodiment shown by FIG. 1, the target device includes a low-level control interface engine 104 receiving input data from the interface module 103. The target device may also include a high-level control interface engine 105, an application interface and a communication module 107. However, in different embodiments, the target device may include different and/or additional components.

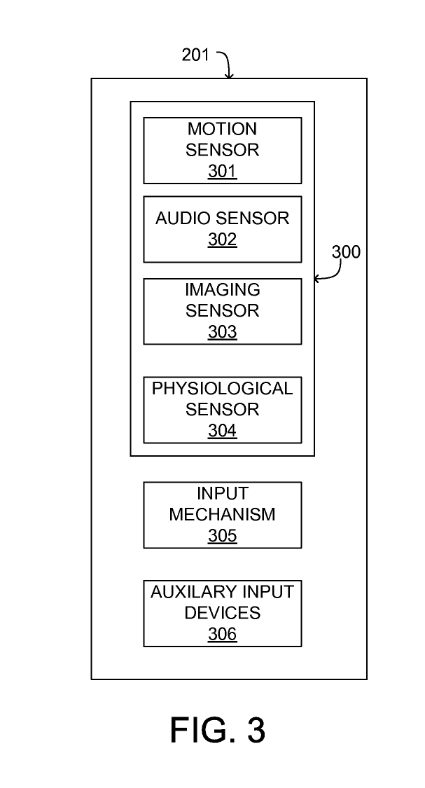

The portable interaction module 102 receives input from a user, such as control signals or other data. In an embodiment, the portable interaction module 102 receives input from a user through multiple channels, such as capturing gestures, identifying movement, capturing audio data, capturing video or image data or other types of input. Capturing multiple types of input using different channels simplifies user-interaction with the target device by allowing a user to provide input using preferred techniques or techniques most suited for an operating environment. In an embodiment, the portable interaction module 102 is coupled to multiple sensors, or includes multiple sensors, to capture different types of input from different locations. For example, the portable interaction module 102 captures input from different regions of a user's body to allow full-body immersive interaction with a target device. In an embodiment, the portable interaction module 102 has a modular design, allowing customization of controller design or configuration based on different implementation parameters or user preferences. In an embodiment, up to 20 channels may be used to allow the portable interaction module 102 to receive input from up to 20 portable input devices. Further, the portable interaction module 102 may also provide feedback from the target device to the user, such as vibrational or other haptic feedback. The portable interaction module 102 is further described below in conjunction with FIGS. 3, 4, 8A and 9.

The interface module 103 is coupled to the portable interaction module 102 and to the low-level control interface engine 104. Input data received or captured by the portable interaction module 102 is communicated to the interface module 103 for transmission to the target device. In an embodiment, the interface module 103 reformats, or otherwise modifies, the input data before transmission to the target device. The interface module 103 may comprise hardware or firmware enabling wireless and/or wired communication, such as a wireless transceiver. Alternatively, the interface module 103 enables a wired connection using a protocol such as Universal Serial Bus (USB), Institute of Electrical and Electronics Engineers (IEEE) 1394, Ethernet or similar data transmission protocol. In an embodiment, the interface module 103 simplifies communication by enabling plug-and-play functionality between the portable interaction module 102 and the target device after an initial installation process. While shown in FIG. 1 as discrete components, in various embodiments a single component includes the interface module 103 and the portable interaction module 102.

The target device, such as a desktop computer, a laptop computer, a gaming system or other computing system, includes a low-level control interface engine 104 receiving data from the interface module 103. The low-level control interface engine 104 may also receive control signals, or other data, from conventional input devices, such as a keyboard or a mouse. In various embodiments, the low-level control interface engine 104 comprises hardware or firmware for wireless and/or wired communication, such as a wireless transceiver or a wired connection as described above in conjunction with the interface module 103. The low-level control interface engine 104 provides a communication framework with the interface module 103 to facilitate communication of data between the portable interaction module 102 and the target device. In an embodiment, the low-level control interface engine 104 reformats received data to simplify processing of received data or execution of commands included in received data.

In an embodiment, the target device also includes a high-level control interface engine 105 coupled to the low-level control interface engine 104. The high-level control interface engine 105 executes a command or modifies data responsive to received input. For example, the high-level control interface engine 105 executes a command extracted from received data by the low-level control interface engine 104 and accesses data identified by the command, initiates an application associated with the identified command or modifies stored data responsive to the identified command. The high-level control interface engine 105 may identify an application or function associated with received data and modify the received data into a command or into data formatted for use by the identified application or formatted to execute an identified command. For example, the high-level control interface engine 105 identifies that the received data is associated with a gaming application and extracts a navigation command from the received data to modify data associated with the gaming application, such as an object's position within the gaming application. In an embodiment, the low-level control interface engine 104 and the high-level control interface engine 105 are combined to provide a single control interface engine.

The high-level control interface engine 105 communicates data with an application interface 106 which allows a user to access and modify a data file on the target device. The application interface 106 may also generate output, such as visual, auditory or haptic feedback, to convey information to a user. In an embodiment, the application interface 106 communicates a subset of the output to the portable interaction module 102 using the interface module 103, the low-level control interface engine 104 and/or the high-level control interface engine 105.

In an embodiment, the target device also includes a communication module 107, enabling the target device to exchange data with one or more additional computing systems. The communication module 107 may enable communication via any of a number of known communication mechanisms, including both wired and wireless communications, such as Bluetooth, WiFi, RF, Ethernet, infrared and ultrasonic sound.

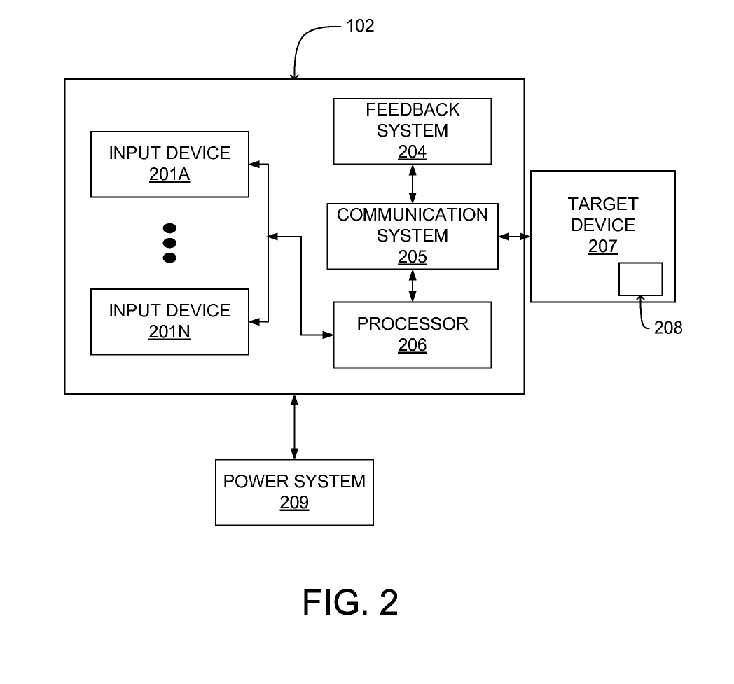

FIG. 2 is a high-level block diagram of an alternate embodiment of a system 200 including a portable interaction module 102. In the system 200 depicted by FIG. 2, the portable interaction module 102 includes one or more input devices 201A-201N which communicate data to a processor 206. A communication system 205 receives data from the processor 206 and communicates data between the portable interaction module 102 and a target device 207. The communication system 205 also communicates data from the portable interaction module 102 to a feedback system 204. A power system 209 is also coupled to the portable interaction module 102.

The portable interaction module 102 includes one or more portable input devices 201A-201N. In an embodiment, the portable input devices 201A-201N include one or more input mechanisms, such as one or more keys, buttons, light sensors, touch sensors, physiological sensors or other mechanisms which receive input from a user or from an environment and a storage device. For example, a portable input device 201 may include multiple input mechanisms and/or sensors, allowing the input device 201 to receive different types of input. For example, the portable input device 201 includes different types of sensors, such as audio sensors, imaging sensors, motion sensors, physiological sensors or other types of sensors. In an embodiment, a storage device is coupled to the one or more input devices 201 and store data identifying input mechanisms and/or sensors which previously received input. The input device 201 is further described below in conjunction with FIG. 3.

The sensors and input mechanisms, further described below in conjunction with FIG. 3, allow an input device 201 to receive input through multiple channels, such as capturing gestures, identifying movement, capturing audio data, capturing video or image data or other types of input, simplifying interaction with the target device 207 by enabling use of a variety of input types. Additionally, the sensors allow the input device 201 to receive a spectrum of input types, such as gesture capture, voice capture, video capture, image capture or physiological data capture, allowing for a more natural interaction between a user and the target device 207. In an embodiment, the types of input captured provide a user with a range of input options similar to conventional user actions or movements, allowing translation of a user's actions into input understandable by the target device 207.

The portable input devices 201A-201N exchange data with a processor 206 A which processes and/or modifies data from the portable input devices 201A-201N. The processor 206 is also coupled to the feedback system 204 and/or the communication system 205, to communicate processed or modified data to one or more of the feedback system 204 and/or the communication system 205.

The communication system 205 also communicates with the feedback system 204 and/or the target device 207 using any of a number of known communication mechanisms, including wireless communication methods, such as Bluetooth, WiFi, RF, infrared and ultrasonic sound and/or wired communication methods, such as IEEE 1394, USB or Ethernet. By enabling wireless communication between the portable interaction module 102 and the target device 207, the communication system 205 allows the portable interaction module 102 to provide input to the target device 207 while within a wireless transmission range, allowing a user to freely move around while interacting with the target device 207. In an embodiment, the communication system 205 is included in the portable interaction module 102; however, in other embodiments, the communication system 205 is external to the portable interaction module 102. For example, the communication system 205 may be included in a docking station or other device which is communicatively coupled to the portable interaction module 102 and/or the target device 207.

A power system 209, such as a battery or other suitable power supply, is coupled to the portable interaction module 102 to provide power for performing computing functionality and/or communicating data portable interaction module 102. In an embodiment, the power system 209 also supplies power to the target device 207.

The feedback system 204 receives data from the target device 207 and/or portable interaction module 102 via the communication system 205 and generates control signals causing the portable interaction module 102 to produce auditory or tactile feedback. For example, the feedback system 204 initiates vibrational feedback, or other haptic feedback, affecting the portable interaction module 102 responsive to data from the target device 207 or responsive to data from the portable interaction module 102. As another example, the feedback system 204 initiates haptic or auditory feedback indicating an input device 201 has captured input. In yet another example, the feedback system 204 initiates audible or vibrational feedback when the target device 207 performs an action or encounters an error.

The target device 207 is a desktop computer, a laptop computer, a gaming console, a set top box, a television or other computing device, and it may be coupled to the communication system 205 via a wired or wireless connection. The target device 207 includes a user interface 208 processing received data and presenting output to a user. For example, the user interface 208 is a graphical user interface, or other application, receiving one or more input types, such as captured gestures, detected motion, captured audio data, captured video or image data or other types of input from the portable interaction module 102. The user interface 208, or other application, may also generate one or more types of output data, such as producing visual output responsive to detected motion or captured audio data or producing audio output responsive to capturing video or image data.

FIG. 3 is a high-level block diagram of an input device 201 including one or more sensors 300, one or more input mechanisms 305 and/or one or more auxiliary input devices 306. The sensors 300 may comprise one or more of a motion sensor 301, an audio sensor 302, an imaging sensor 303, a physiological sensor 304 or combinations of the previously-described types of sensors. In other embodiments, the sensors 300 comprise different and/or additional sensors and the sensors 300 shown in FIG. 3 are merely examples types of sensors 300. Different users may customize the sensors 300, allowing use of different types of sensors 300 or combinations of different types of sensors 300 to be based on user preferences or implementation environments. Using different sensors 300 provides more interactive and engaging interactions with the target device 207 by capturing inputs using a variety of methods. Additionally, the sensors 300 may be used to provide feedback, such as tactile or audio feedback, from the target device 207 to further enhance interaction with the target device 207 by creating a richer sensory environment.

Including one or more sensors 300 in addition to one or more input mechanisms 305 improves user interaction with a target device 207 by increasing the number and types of inputs which may be received. The motion sensor 301 comprises an accelerometer or other device capturing data describing the movement and/or orientation of the portable interaction module 102. In an embodiment, movements of the portable interaction module 102 are associated with commands, or other input, of an application executed by the target device 207. In an embodiment, multiple motion sensors 301 may be used to monitor movement of different areas, such as movement of different parts of a user's body or movement of different areas within an environment.

The audio sensor 302 comprises one or more microphones capturing audio data. In an embodiment, the captured audio data is processed to identify a command, such as a keyword or a key phrase, which is communicated to a target device 207. For example, the audio sensor 302 includes a speech recognition processor or application to identify portions of the captured audio data, such as commands. The audio sensor 302 may also include one or more speakers playing audio data generated by the e target device 207 or by the feedback system 204.

The imaging sensor 303 comprises one or more cameras, or other optics and sensors, for capturing image or video data of an environment surrounding the handheld controller 102. The captured image or video data is communicated to the processor 206 for analysis. In an embodiment, captured image or video data is used to detect and track movement of the portable interaction module 102, which may be converted into input data or commands for a target device 207. Alternatively, the imaging sensor 303 may capture data, such as a user's facial expression or other environmental data to allow a target device 107 to identify the user or identify the environment surrounding the portable interaction module 102. Additionally, image data or video data captured by the imaging sensor 303 may be subsequently processed to enhance the received data or identify content within the received data.

The physiological sensor 304 at least partially contacts a user and captures data associated with the user, such as cardiovascular activity, skin conductance, skin temperature, perspiration level or similar physiological data. The captured physiological data may be used by the portable interaction module 102 or the target device 207 to determine an attribute of a user, such as a stress level, an excitement level, an anxiety level or another state associated with a user. In an embodiment, data captured by the physiological sensor 304 is combined with data from the motion sensor 301 the audio sensor 302 and/or the imaging sensor 303 to determine a state associated with the user. For example, a captured image of the user's face, captured audio from the user and captured physiological data is analyzed to identify a user's state, such as an emotional state associated with the user.

In an embodiment, the different sensors 300 exchange data with each other to improve the accuracy of data captured by the sensors 300. For example, an input device 201 may initially capture image data using the imaging sensor 303. Subsequently, data from the motion sensor 301 and/or the audio sensor 302 is captured and processed to more accurately identify content within the captured image data. By exchanging data among the motion sensor 301, the audio sensor 320, the imaging sensor 303 and the physiological sensor 304, multiple data sources are used to improve the accuracy of input obtained by the input device 201 and reduce the amount of noise captured by individual types of sensors.

The input mechanism 305 receives input from user interaction with the input mechanism 305. For example, the input mechanism 305 may comprise buttons, keys, touch sensors, light sensors or other mechanisms which receive user interaction with the mechanisms themselves.

In an embodiment, one or more auxiliary input devices 306 are coupled to the input device 201 allowing input to be received from additional locations or allowing different types of input to be received. For example, the auxiliary input device 306 is a second portable interaction module 102 receiving input from a different location, such as from a different position on a user's body, from a different location within an operating environment or from a different user. As another example, the auxiliary input device 306 comprises one or more sensors positioned in a different location than the portable interaction module 102. In an embodiment, up to 20 auxiliary input devices 306 may exchange data with the input device 201. Data exchange between the input device 201 and the auxiliary input device 306 may be modified based on user preferences, operating characteristics or other parameters.

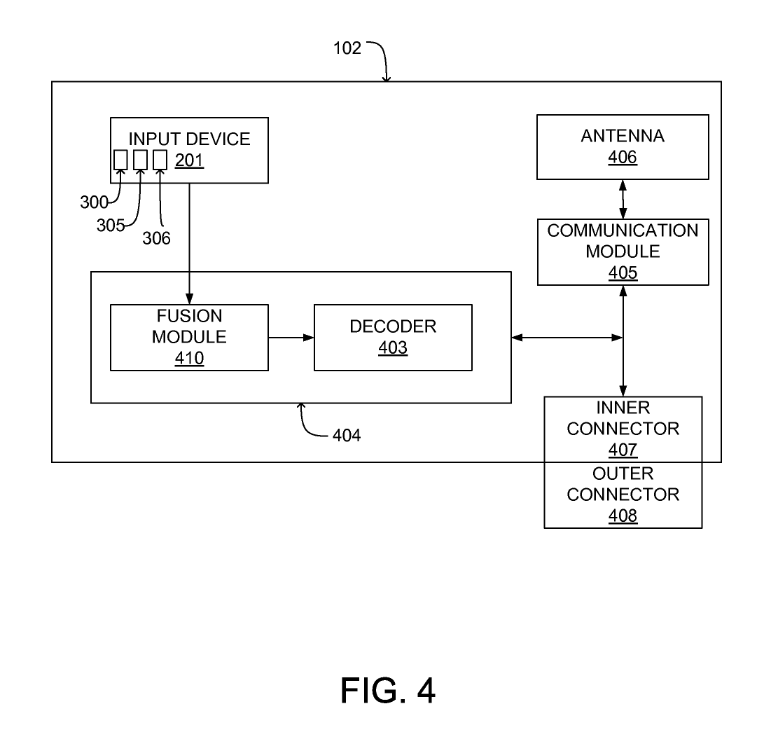

FIG. 4 is a high-level block diagram of an embodiment of a portable interaction module 102 including an input device 201, a decoder 403, a processor 404 and a communication module 405. In an embodiment, the portable input device 201 also includes an antenna 406, an inner connector 407 and an outer connector 408.

As described above in conjunction with FIGS. 2 and 3, the input device 201 includes one or more sensors 300 and one or more input mechanisms 305. Additionally, the input device 201 may also exchange data with one or more auxiliary input devices 306. The input mechanisms 305 may be keys, buttons, touch sensors, light sensors or any other mechanism for receiving an input. In an embodiment, the input mechanisms 305 have a predefined orientation, such as forming one or more rows a forming the circumference of a circular region, providing an ergonomic design for user access. Additionally, the orientation of the input mechanisms 305 within the input device 201 may be modified or customized based on individual preferences or implementation-specific parameters. Different types of input mechanisms 305 may be included on the input device 201. For example, the input device 201 may include touch sensors and keys, buttons and light sensors or any combination of mechanisms for receiving input from a user or from an environment surrounding the input device 201. The sensors 300 comprise one or more of a motion sensor 301, an audio sensor 302, an imaging sensor 303, a physiological sensor 304 or any other type of sensor capturing data describing an environment in which the portable interaction unit 102 is operated.

In an embodiment, a fusion module 410 is coupled to the input device 201 and receives data from the input mechanisms 305 and one or more of the sensors 300, such as at least one of a motion sensor 301, an audio sensor 302, an imaging sensor 303 or a physiological sensor 304. In an embodiment, the input device 201 also communicates input from an auxiliary input device 306 to the fusion module 410. The fusion module 410 combines data from one or more input mechanisms 305, one or more sensors 300 and/or one or more auxiliary input devices 306 to produce a description of the data received by the input device 201.

The decoder 403 is coupled to the fusion module 410 and determines the status of different input mechanisms 305, sensors 300 and/or auxiliary input devices 306 providing data to the input device 201. In an embodiment, the decoder 403 is coupled to a storage device, such as Random Access Memory (RAM) or other storage device, which stores data describing a state associated with different input mechanisms 305, sensors 300 and/or auxiliary input devices 306 providing data to the input device 201. For example, the storage device stores an indicator associated with individual input mechanisms 305, individual sensors 300 and/or individual auxiliary input devices 306 describing whether an input mechanism 305, a sensor 300 and/or an auxiliary input device 306 was previously accessed by a user or previously captured data, such as an indicator describing whether or not a button has been depressed, describing whether or not a light sensor detected light or whether or not a motion detector detected motion

In an embodiment, the decoder 403 and the fusion module 401 are implemented by computer program code stored on a memory and configured to be executed by the processor 404, the computer program code including instructions that cause the processor 404 to perform the above-described functionality when executed. The processor 404 which processes stored data associated with individual input mechanisms 305, individual sensors 300 and/or individual auxiliary input devices 306 to implement the functionality of the decoder 403. For example, the processor 404 generates a representation of the state of different individual input mechanisms 305, individual sensors 300 and/or individual auxiliary input devices 306 from data in a storage device to determine the status of components providing data to the input device 021. The processor 404 may also delete stored data used by the decoder 403 to allow storage of indicator values describing a more recent state of different individual input mechanisms 305, individual sensors 300 and/or individual auxiliary input devices 306.

A communication module 405 is coupled to the processor 404 and communicates data from the processor 404 to a target device or another device using any of a number of known wireless communication techniques, such as Bluetooth, WiFi, RF, infrared and ultrasonic sound. In an embodiment, an antenna 406 is coupled to the communication module 405 to transmit data via one or more wireless communication mechanisms.

In an embodiment, the processor communication module 405 is also coupled to an inner connector 407 enabling data communication using a wired communication technique. The inner connector 407 is coupled to an outer connector 408 which may be coupled to an external device. Data from an external device is communicated from the outer connector 408 to the inner connector 407 which communicates the data to the communication module 405 or the processor 404. In an embodiment, the outer connector 408 and inner connector 407 communicate configuration information to the processor 404 to modify operation of the portable interaction module 102. Additionally, the inner connector 407 receives data from the processor 404 and communicates the received data to the outer connector 408 for communication to an external device using a wired communication protocol, such as Universal Serial Bus (USB). For example, the inner connector 407 and out connector 408 are used to transmit diagnostic information to an external device to determine processor 404 performance.

### Controller Operation and Configuration

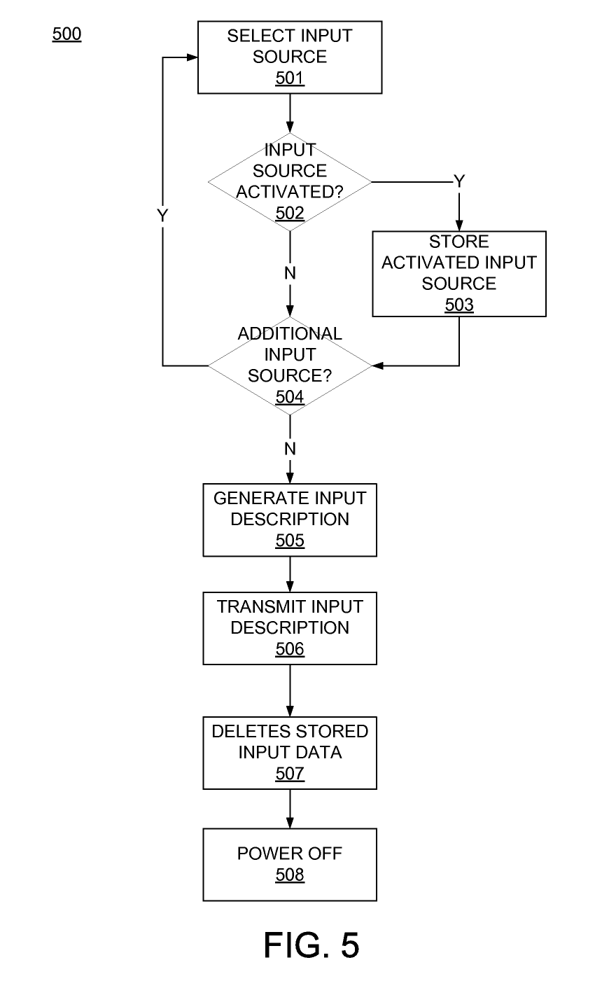

FIG. 5 is a flow chart of a method 500 for receiving input from an input device 201 according to an embodiment of the invention. The method 500 captures input received by one or more input sources included in the input device 201. Examples of input sources include input mechanisms 305, such as keys, buttons, touch sensors, light sensors or any other mechanism for receiving an input. Additional examples of input sources include one or more sensors 300, such as motion sensors 301, audio sensors 302, imaging sensors 303 or physiological sensors 304. An input source may also be an auxiliary input device 306 communicating data to the input device 201.

An input source, such as a predetermined input source, is initially selected 501. An indicator associated with the selected input source and stored in the decoder 403 is examined to determine 502 whether the selected input source has received input. The method 500 may also be used to determine whether an auxiliary input device 306 has received an input or otherwise been activated. For example, the stored indicator specifies whether a selected key or button has been depressed, whether a selected motion detector has identified motion, whether a selected light sensor has been exposed to light or whether another type of input source has been activated. If the indicator associated with the selected input source indicates that the selected input source has received an input, or has been “activated,” an identifier associated with the selected input source is stored 503 in the decoder 403. In an embodiment, the decoder 403 appends the identifier associated with an activated input source to a data collection, such as a data string or queue, to identify different input sources that have been activated.

After storing 503 the identifier associated with the activated input source, the decoder 403 determines 504 whether additional input sources have not previously been selected. Similarly, responsive to determining 502 that a selected input source has not been activated, the decoder 403 determines 504 whether additional input sources have not previously been selected 504. In an embodiment, a specified set of input sources are evaluated for activation. Alternatively, each input source is evaluated for activation. In another embodiment, input sources are evaluated for activation until a determination is made that a specific input source was activated or was not activated. If additional input sources have not been selected, a different input source is selected 501 and the decoder 403 determines 502 whether the newly selected input source has been activated.

After determining 504 that additional input sources do not require determination of activation, an input description is generated 505 by the decoder 403. In an embodiment, the input description is the data collection identifying activated input sources stored and associated with the decoder 403 as described above. In an embodiment, the decoder 403 reformats or otherwise modifies the data collection identifying activated input sources to simplify transmission of or subsequent processing of the input description. The communication module 405 then transmits 506 the input description to the target device and the decoder 403 deletes 507 the input description and/or the data collection identifying activated input sources. In an embodiment, the decoder 403 deletes 507 the data collection identifying activated input sources responsive to receiving an acknowledgement message from the target device 207. Alternatively, the decoder 403 stores the data collection identifying activated input sources or the input description for a predetermined interval before deletion. In an embodiment, the method 500 ceases when power to the portable input device 201 is terminated 508.

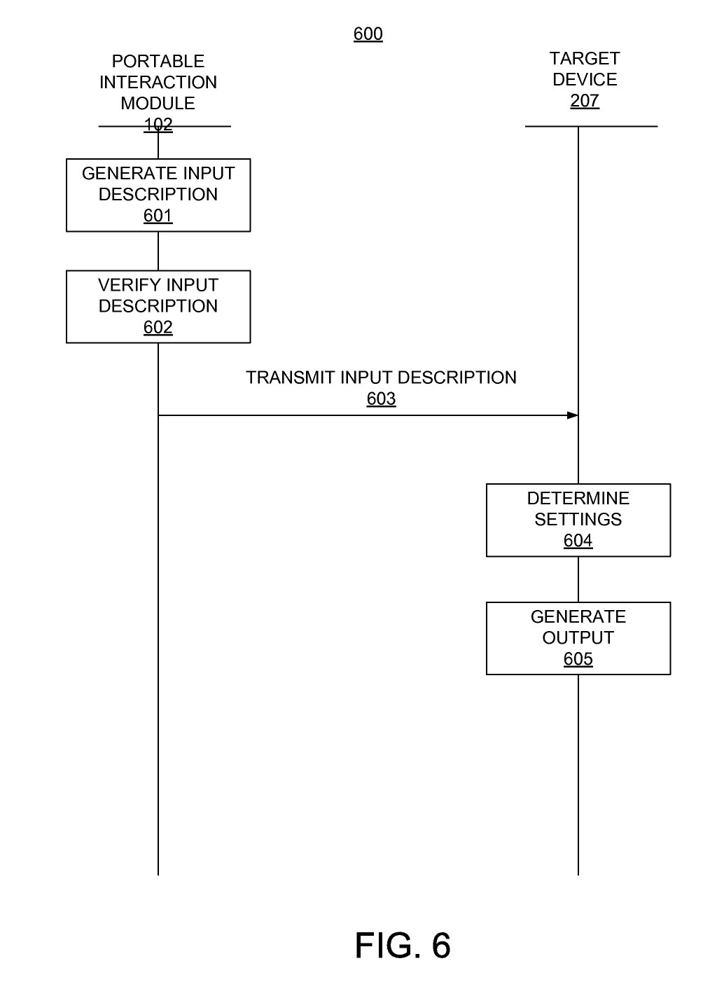

FIG. 6 is an event diagram of an embodiment of a method 600 for generating output responsive to input received by the portable interaction module 102. As one or more input sources receive input, an input description is generated 601 by the decoder 403 included in the portable interaction module 102. The input description is generated 601 as described above in conjunction with FIG. 5. In an embodiment, the processor 404 also verifies 602 the accuracy of the input description. For example, the processor 404 verifies 602 that the input description is complete or includes information from a predefined input source. Additionally, the processor 404 may verify 602 that the input description is in a format compatible with the target device 207 or that the input description is in a format suitable for transmission using a wireless or wired communication protocol.

The input description is then transmitted 603 from the portable interaction module 102 to a target device 207 via communication system 205. Upon receiving the input description, the target device 207 determines one or more settings associating one or more input descriptions with one or more applications or commands executed by the target device 207. The settings may be user specific, allowing individual users to specify how input received by the portable interaction module 102 initiates actions by the target device 207. Alternatively, the settings may be associated with an application or operating environment implemented by the target device 207. These settings allow greater customization of portable interaction module 102 uses and simplify interaction with the target device 207. The determined settings are used by the target device 207 to generate 605 output responsive to the received input description. The generated output may be audio or visual data presented by the target device 207, or may be communicated from the target device 207 back to the portable interaction module 102 to provide vibrational or other haptic feedback.

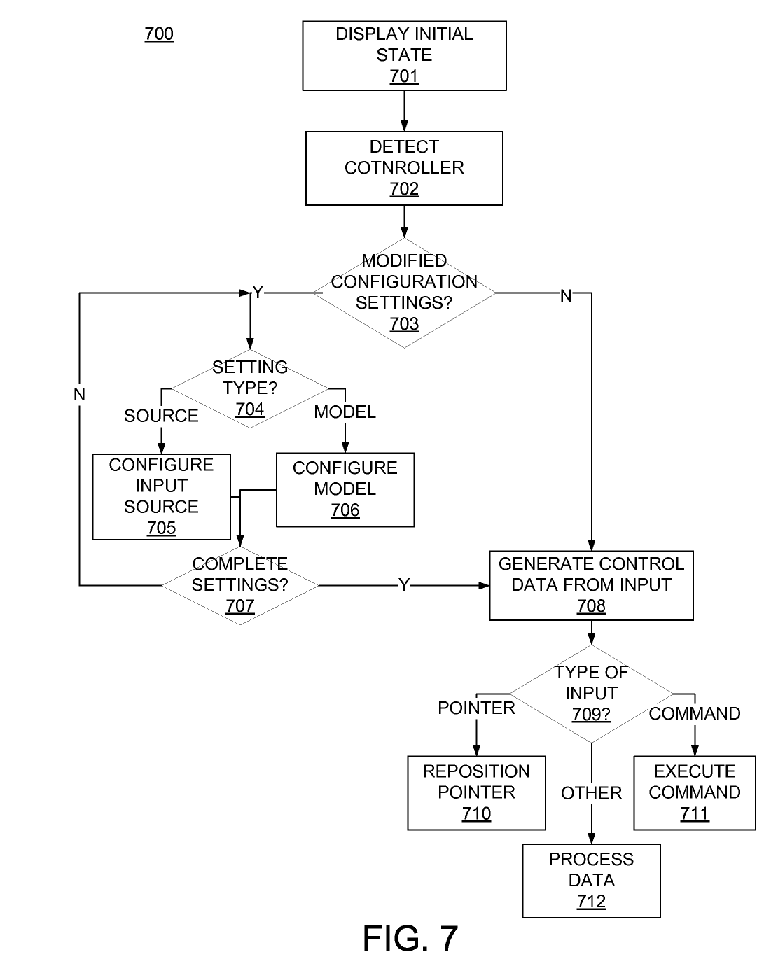

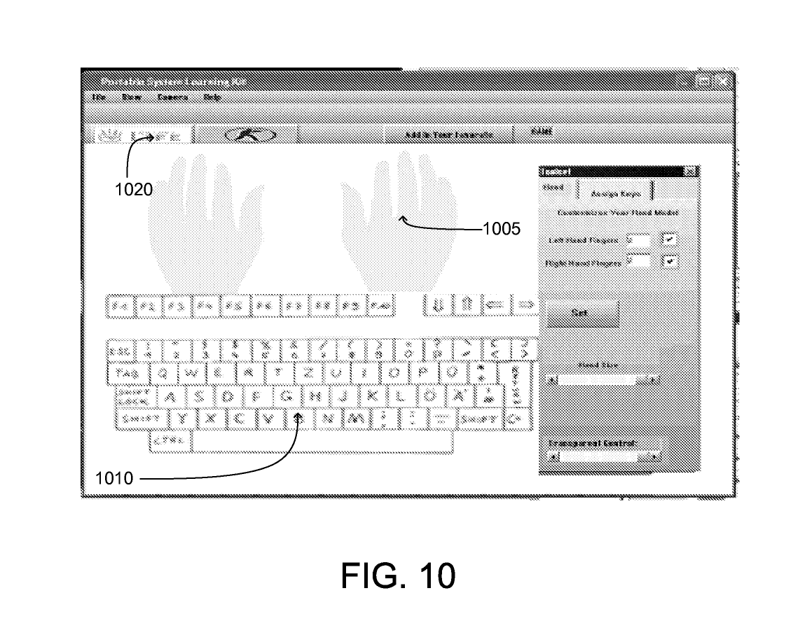

FIG. 7 depicts a flow chart of a method 700 for configuring a system including a portable interaction module 102. Steps of the method 700 may be executed by different functional modules such as a human device interface driver interfacing the portable interaction module 102 and the target device 207 and a graphical user interface (GUI) presented by the target device 207. An example GUI for configuring a portable interaction module 102 is further described below in conjunction with FIG. 10.

When a portable interaction module 102 initially communicates with a target device 207, the method 700 is implemented. For example, the method 700 begins when the portable interaction module 102 establishes communication with the target device 207 or responsive to the target device 207 receiving a configuration message from the portable device 102. The target device 207 displays 701 an initial state, such as a display identifying a user associated with the target device 207, whether the target device 207 is communicating with the portable interaction module 102 or other information. The target device 207 then detects 702 the portable interaction module 102. For example, the target device 207 receives a communication message or an acknowledgement message from the portable device 102.

After detecting 702 the portable interaction module 102, the target device 207 determines 703 whether one or more configuration settings associated with the portable interaction module 102 have been modified. The configuration settings allow a user to customize interaction between the portable interaction module 102 and the target device 207. For example, the configuration settings associate an application or command with one or more input mechanisms 305 and/or sensors 300, allowing customization of the input mechanisms 305 or sensors 300 which cause the target device 207 to perform an action or execute an application. Modifying configuration settings allows a user or application maximize the efficiency of interactions with the target device 207 or improve the enjoyment of interacting with the target devise 207 through customization of inputs received from the portable interaction module 102.

If the target device 207 determines 703 that a configuration setting is modified, a type associated with the modified configuration setting is determined 704. In an embodiment, configuration settings may modify a command, action or application associated with one or more input sources, such as input mechanisms 305, sensors 300, auxiliary input devices 306 or combinations of the previously described components, or may modify a model used by the target device 207 to describe operation and/or movement of the portable interaction module 102. Modifying the model describing operation and/or movement of the portable interaction module allows the target device 207 to more accurately monitor movement of the portable interaction module 102 or instruct a user about operation of the portable interaction module 102. Determining 704 that the modified configuration setting modifies an input source causes the target device 207 to configure 705 an application or action associated with the modified source using the modified configuration setting while determining 704 that the modified configuration setting modifies a model associated with the portable interaction module 120 causes the target device 207 to configure 706 the model associated with the portable interaction module 102 according to the modified configuration setting.

After configuring 705 an input source or configuring 706 the model, the target device 207 determines 707 if additional configuration settings are modified. If additional settings are modified, the type of the additional modified settings is determined 704 and an input source or a model is configured 705, 706 accordingly. Upon determining 707 that additional configuration settings are not modified or determining 703 that configuration settings are not initially modified, the target device 207 generates 708 control data from an input description received from the portable interaction module 102.

In an embodiment, an input type is determined 709 from the generated control data. Determining 708 that the control data is pointer data, the target device 207 repositions 710 a pointer, a cursor or another object. If the target device 207 determines 709 the control data is associated with a command, the identified command is executed 711. If the target device 207 determines 709 that the control data is another type of data, the data is processed 712 by the target device 207 or by an application. For example, if the control data is Software Development Kit (“SDK”) data, originated from one or more sensors 300 or input mechanisms 305, the SDK data is processed at 712 to modify or configure an application on the target device 207. Hence, input from the portable interaction module 102 may be used to supply data or commands to the target device 207 or to applications operating on the target device 207 or may be used to navigate throughout an application or operating system executed by the target device 207.

In various embodiments, the steps depicted in the methods 500, 600, 700 described above are implemented by instructions for performing the described actions embodied or stored within a computer readable medium, such as a persistent storage device or a nonpersistent storage device, which are executable by a processor, such as processor 206 or processor 404. Those of skill in the art will recognize that the methods 500, 600, 700 may be implemented in embodiments of hardware and/or software or combinations thereof.

### Example Configurations

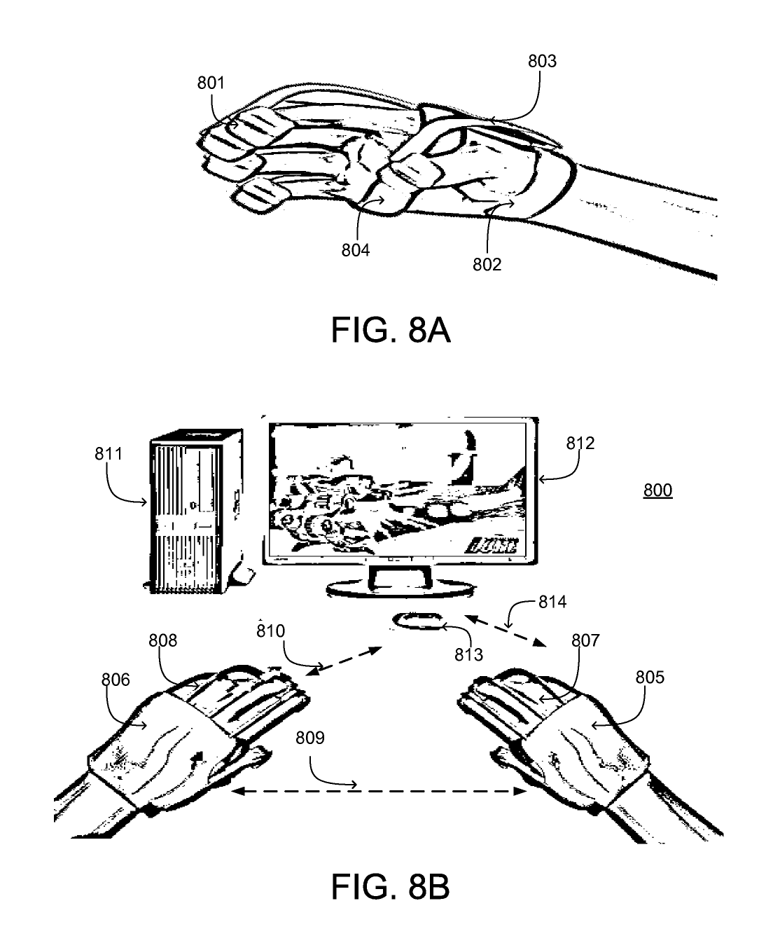

FIG. 8A shows an example configuration of a portable interaction module 102 as a glove shaped input device 803. In the configuration shown by FIG. 8A, the glove shaped input device 802 includes a first adjustable housing member 803, such as a belt, and a second adjustable housing member 804, such as a second belt, which are used to affix the glove shaped input device 802 to an object, such as a user's hand. Additionally, the example configuration includes multiple cubics 801 which how one or more input devices 210, each including one or more input mechanisms 305 and/or sensors 300 on a first surface. In an embodiment, an object, just as a user's finger is included in a cubic and proximate to the first surface, allowing the object to access the one or more input mechanisms 305 and/or sensors 300.

FIG. 8B is an example system 800 including a portable interaction unit 102 having a glove-like configuration. A first glove shaped input device 806 is placed on a first object 808, such a one hand of a user, and a second glove shaped input device 805 is placed on a second object 807, such a second hand of a user. For example, a user wears the first glove shaped input device 806 on the user's right hand and wears the second glove shaped input device 805 on the user's left hand.

In the system 800 shown by FIG. 8B, the first glove shaped input device 806 includes a communication system for communicating data or commands to a target system 811 using a communication channel 810, such as a wireless connection. Hence, data is communicated from the second glove shaped input device 805 to the first glove shaped input device 806 using a communication channel 809, such as a wireless communication channel. The communication channel 809 allows the first glove shaped input device 806 to combine signals from the glove shaped input devices 805, 806. The first glove shaped input device 806 then communicates the combined signals to a communication system 813 coupled to the target system 811 using the communication channel 810. The second glove input device 805 may also communicate directly to the communication system 813 using communication channel 814. Responsive to receiving the combined signals, the target system 811 generates an output that may be presented to the user via a display 812, or may be presented as an audible signal or tactile feedback.

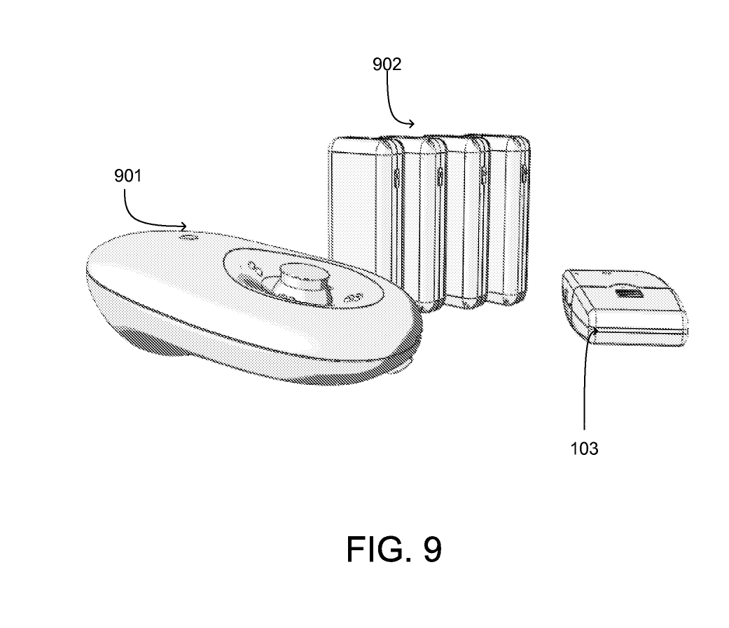

FIG. 9 shows an alternative configuration of a portable interaction module 102 comprising two modules, a portable sensor module 901 and an attachable sensor module 902. The portable sensor module 901 includes one or more sensors, such as those described above in conjunction with FIG. 3, capturing a variety of input types, simplifying user interaction with a target device 207. For example, a user may grasp or hold the portable sensor module 901 or position the portable sensor module 901 proximate to the user to capture input. Similarly, the attachable sensor module 902 may be attached to a user, such as attached to a wrist, ankle or body part of a user, or positioned proximate to the user, such as attached to a belt, a shoe or another article of clothing worn by a user. The interface module 103 receives data from the portable sensor module 901 and/or the attachable sensor module 902 and communicates the received data to a target device 207. For example, the interface module 103 supports one or more wireless communication protocols for data communication.

FIG. 10 is an example user interface for configuring a portable interaction module 102 according to an embodiment of the invention. The user interface may be displayed by a target device 207 or another computing device coupled to the portable interaction module 102. The user interface shown in FIG. 10 is a graphical user interface (GUI) allowing user customization of portable interaction module operation.

The GUI allows a user to customize the inputs associated with one or more input mechanisms 402 of an input device 201 within the portable interaction module 102. For example, the GUI allows a user to associate a keyboard key with an input from the portable interaction module 102 by dragging a graphical representation of a key from a graphical representation of a conventional keyboard 1010 to an input mechanism 305 of an input device 201, such as dragging a graphical representation of a key to a graphical representation of a finger 1005 so that motion, or other input, of the identified finger is associated with the selected key.

Additionally, the GUI may include a simulation application allowing a user to calibrate an input device 201, sensors 300 within the input device 201, input mechanisms 305 within the input device 210 or practice use of the entire portable interaction module 102. In an embodiment, the simulation engine displays on the target device 207 a three-dimensional graphical representation of a hand relative to a three-dimensional graphical representation of the portable interaction module 102 and illustrates interaction with the portable interaction module 102 through movement of the three-dimensional representation of the hand relative to the three-dimensional graphical representation of the portable interaction module 102. For example, the three-dimensional graphical representation of the hand emulates pressing, or otherwise activating, an input sensor shown on the three-dimensional graphical representation of the portable interaction module 102.

In an embodiment, the GUI also stores a workbench 1020 identifying applications or games frequently accessed by a user or identifying applications or games selected by a user. The workbench 1020 allows the user to more quickly access certain games or applications.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A multi-channel portable interaction module comprising:
one or more input devices, each input device including a plurality of input mechanisms for receiving input responsive to an interaction and one or more sensors for capturing data associated with an environment surrounding the input device;
a processor coupled to the one or more input devices;
computer program code stored on a memory and configured to be executed by the processor, the computer program code including instructions for:
receiving data from the plurality of input mechanisms and from the one or more sensors;
generating data describing at least one of: an input received by an input mechanism and the data captured by a sensor and
generating an input description identifying input mechanisms or sensors having received input;
providing an identifier associated with each input mechanism indicating whether individual input mechanisms have received input
providing an identifier associated with each sensor indicating whether individual sensors have captured data; and
generating transmission data associated with the input description;
a communication module coupled to the processor, the communication module for transmitting the transmission data to a target electronic machine.

2. The multi-channel portable interaction module of claim 1, further comprising:
a feedback system coupled to the target device and to the communication module, the feedback system generating feedback responsive to feedback data received from the target device.

3. The multi-channel portable interaction module of claim 2, wherein the feedback system is configured to initiate tactile feedback by the multi-channel portable input device responsive to the feedback data.

4. The multi-channel portable interaction module of claim 1, wherein the one or more input devices comprise up to twenty input devices.

5. The multi-channel portable interaction module of claim 1, wherein the one or more sensors comprise at least one of a motion sensor, an audio sensor, an image sensor, and a physiological sensor.

6. The multi-channel portable interaction module of claim 5, wherein an input device is configured to receive input from an auxiliary input device external to the multi-channel portable interaction module.

7. The multi-channel portable interaction module of claim 5, wherein the fusion module is configured to generate a description of data captured by two or more sensors and an input received by a first input mechanism, each sensor capturing a different data type.

8. The multi-channel portable interaction module of claim 7, wherein the data type comprises at least one of audio data, video data, image data, audio data, motion data, and physiological data.

9. The multi-channel portable interaction module of claim 1, wherein the communication module is further coupled to an auxiliary input device in a location remote from the multi-channel portable input device.

10. The multi-channel portable interaction module of claim 1, further comprising one or more adjustable physical members.

11. A computing system comprising:
a portable input device including a plurality of input mechanisms for receiving input responsive to an interaction and one or more sensors for capturing data associated with an environment surrounding the multi-channel portable input device, the portable input device configured to generate an input description describing at least one of: an input received by an input mechanism and the data captured by a sensor;
a target device coupled to the portable device and including an output device, the target device configured to receive the input description from the portable input device, generate an output from the input description, and present the output using the output device.

12. The computing system of claim 11, wherein the output comprises a visual signal and the output device comprises a display device.

13. The computing system of claim 11, wherein the target device includes a setting associating the input description with the output.

14. The computing system of claim 13, wherein the setting associates a command with input received by the input mechanism or with data captured by the secondary input device.

15. The computing system of claim 11, wherein the target device is selected from a group consisting of a robot, a computer, a set top box, a television and a gaming system.

16. The computing system of claim 11, further comprising an auxiliary input device coupled to the portable input device, the auxiliary input device for capturing data from a second location and communicating the captured data to the portable input device.

17. The computing system of claim 11, wherein the one or more sensors comprise at least one of a motion sensor, an audio sensor, an image sensor, and a physiological sensor.

18. The computing system of claim 17, wherein the input description describes data captured by two or more sensors and an input received by a first input mechanism, each sensor capturing a different data type.

19. The computing system of claim 18, wherein the data type comprises at least one of audio data, video data, image data, audio data, motion data, and physiological data.

20. The computing system of claim 11, wherein the one or more sensors are positioned at one or more locations in an environment proximate to the multi-channel portable input device.
